(19) United States
(12) Patent Application Publication
(10) Pub. No.: US 2009/0187845 A1
(43) Pub. Date: Jul. 23, 2009

(54) METHOD OF PREPARING AN INTELLIGENT DASHBOARD FOR DATA MONITORING

(75) Inventor: Morten Middelfart, Hjorring (DK)

Correspondence Address: BUCHANAN, INGERSOLL & ROONEY PC, POST OFFICE BOX 1404, ALEXANDRIA, VA, 22313-1404, US

(73) Assignee: Targit A/S, Hjorring (DK)

(21) Appl. No.: 12/300,505

(22) PCT Filed: May 16, 2007
(86) PCT No.: PCT/DK2007/000232

§ 371 Date: Nov. 12, 2008

(30) Foreign Application Priority Data
May 16, 2006 (DK) PA 2006 00689

(51) Int. Cl. G06F 3/048; G06F 17/30

(52) U.S. Cl. 715/772; 707/1; 707/E17.001

(57) ABSTRACT

A computer-implemented method of preparing an electronic dashboard with a data meter for showing a key performance index, KPI. On a first request, preparing a graphical presentation of a dataset, with multiple multi-dimensional data points, selected from a database by use of a set of metadata items or at least a portion of the metadata items; and on a second request, displaying a first value by means of the data meter. Following the first request, recording the set of metadata items. Rating the measure among other measures by calculating an index from values of the items in the set of metadata items. And, following the second request, providing the first value from a specified measure in a predefined way, where the measure is specified by means of: an enquired rating on the performance index, and/or an enquired value of the metric of use, and/or an enquired measure.

### BACKGROUND

Computer-aided data analysis is increasingly used not only by experts in the field of data analysis, but also by professionals in other fields. These professionals demand tools and software applications which to a high degree ease the task aimed at providing a desired data analysis. Such data analysis typically involves display of multiple or a series of multi-dimensional data points to provide sufficient detail in the analysis. Graphs, plots or tables are often used for displaying the multi-dimensional data points.

It may also be desired to have so-called performance indicators or so-called key performance indicators, KPI, displayed. Such indicators provide predetermined or pre-calculated features of the multi-dimensional data points e.g. a feature representing an estimated linear trend, an estimated average across the data points, a predetermined value like a target or goal value etc. Key performance indicators can be displayed by means of data meters arranged in an electronic dashboard. Generally, a data meter is configured to illustrate only a one, two, three; four, or a small collection of numbers. An electronic dashboard displays one or more of such data meters.

In this respect it has been discovered that every improvement to ease the task of performing above-mentioned, is highly appreciated by the professionals.

### SUMMARY OF THE INVENTION

There is provided a computer-implemented method of preparing an electronic dashboard with a data meter for monitoring data, comprising: on a first request, preparing a graphical presentation of a dataset, with multiple multi-dimensional data points, selected from a database by use of a set of metadata items or at least a portion of the metadata items and, on a second request, displaying a first value by means of the data meter.

Following the first request or in connection therewith the method comprises recording the set of metadata items, which comprises: items, comprising a measure and a dimension, which select the dataset from the database, and a metric representing use of the metadata items for preparing graphical presentations.

Further, rating the measure among other measures is performed by calculating an indicator from values of the items in the set of metadata items. This indicator could be a so-called key performance indicator, KPI.

Following the second request, the method comprises: providing the first value from a specified measure in a predefined way, where the measure is specified by means of: an enquired rating on the performance index, and/or an enquired value of the metric of use, and/or an enquired measure. The predefined way of providing the first value from a specified measure is e.g. to provide the measure value associated with a most recent dimension value. Other predefined ways can be defined.

It should be noted that typically the first request is provided by a user who interacts with a user interface to obtain some type of report e.g. comprising charts, curves, tables or like means of presentation. In one way or other, the user specifies the data which it is desired to present in the report. This may involve an iterative process where the user interacts with the user interface modifying or changing his specification so as to obtain a report as desired by the user. Thereby, the user performs a computer-aided data analysis.

Subsequently, when the user requests a display of a key performance indicator, a first value is displayed by means of the data meter. Since metadata items resulting from the above-mentioned iterative processes are recorded, the metadata items, which reflect a user's preferences, can be relied on for preparing the key performance indicator.

The key performance indicator can be prepared from a specified measure in a predefined way. The measure is specified by means of an enquired rating on the performance indicator. It is possible to map values of the measure onto a desired scale and select a certain range on that scale. Thereby, a user can avail himself of the option of having the thereby selected key performance indicator displayed without providing further input.

Alternatively or additionally the measure is specified by means of an enquired value of the metric of use. Such an enquired value can be specified by means of dynamic properties that for instance represents the most frequently used measure or the most recently used measure.

Alternatively or additionally the measure is specified by enquiring the name of a desired measure.

Consequently, information recorded during data analysis can be automatically conveyed to provide display of a key performance indicator from a user activated event e.g. a user activating a button or an automatically activated event e.g. raised by a software application reaching a specified state. Since information recorded during data analysis can be automatically conveyed to provide display of a key performance indicator only very limited user interaction is required to provide the display.

In an embodiment, the items which select the dataset from the database comprise a level of the dimension and a criterion on the dimension. The most frequently used type of dimension is the type “time”. Levels of this type of dimension is e.g. year, month, week, and day. However, other levels may be preferred depending on the origin of data in the database.

It is often desired to estimate trend values so as to make a more clear perception of a trend across a series of data points. Estimation of a trend depends often heavily on a specified term across which the trend is estimated and requires a user to enter such a term. This adds to the number of required user interactions before a satisfactory result is achieved. Thus, the method may comprise: calculating a trend value of the measure over a term of the dimension, where the term is defined by a criterion on the dimension; and by means of the meter, displaying the trend value. Thereby, the user can be relieved from entering the term manually.

In an embodiment, where different sets of metadata items are recorded, the method comprises: from the different sets of metadata items, determining which recorded metadata set that fulfil a predetermined criterion on the metric representing use and the criterion that the criterion on the dimension is used in combination with the measure; and providing that criterion on the dimension so as to define the term of the dimension. Thereby, a user's preferred (as defined by a criterion on the metric of use) term in connection with data analysis is used for calculating the trend estimate. Further, the term is related to a dimension used in combination with the measure.

The method may comprise: displaying a graphical control object, which provides values of the criterion of dimension; and dividing at least a portion of the graphical control object into divisions, where a division represents a level of dimension, and where one or more divisions are selectable from a user interface so as to provide the values of the criterion on the dimension for providing an updated trend value. Thereby a very intuitive, fast and efficient input of values for providing an updated trend value is provided.

In an embodiment the graphical control object provides the values of the criterion on the dimension for providing an updated trend value at multiple data meters. Thereby causality between the multiple data meters is provided.

In an embodiment, where one or more divisions are selectable, one or several divisions can be selected and subsequently a simulation request can be entered e.g. by activating a button. In response thereto a simulation is performed which provides updates of the meters based on shifting the values of the criterion on the dimension over a time interval. Thereby the simulation can reveal visualisation of relationships between different key performance indicators based on very few user inputs.

In an embodiment, the method comprises: calculating a goal value for the measure at a predetermined dimension value based on values of the measure at dimension values fulfilling the criterion; and by means of the data meter, further displaying the goal value. A goal value can be estimated by an expression e.g. providing a goal of a last observation plus 20% or of an average across observations plus 15%.

The method may comprise: recording for the set of metadata items a property representing a desired development of values of the measure; where the goal value is calculated so as to be a function of the property representing a desired development.

The property is e.g. a binary value indicating either that an increasing or decreasing development of measure values is desired. The property is determined from colour coding of a dataset that has been subject to a graphical presentation or from a user's previous assertion of the property. The property is stored with the set of metadata items for subsequent recall. The property can be stored in the form of a sign or value e.g. +1 or −1.

By means of this property the goal can be set relative to existing observations or estimates thereon e.g. an average or a maximum or minimum of observations, but towards a desired development e.g. towards larger or smaller values.

The index can be calculated so as to be a function of a value of the measure, the trend value, and the goal value.

The step of displaying a first value by means of the data meter can comprise displaying a collection of values.

The step of displaying a first value by means of the data meter can comprise displaying a collection of values, and where the collection of values is computed from values of items in the set of metadata items.

Moreover, there is provided a computer program product which when run on a computer performs the method according to the method described above; a computer readable medium encoded with a program which when run on a computer performs the method; and a computer system encoded with a program which when run on a computer performs the method.

Generally, a key performance index, KPI, can be defined in different ways, but comprises e.g.:
a goal value, a measure value and a trend value;
a measure value and a trend value;
a goal value and a measure value;
a goal value and a trend value;
a measure value;
a goal value; or
a trend value.

Below is a detailed description of embodiments in connection with the drawing in which:

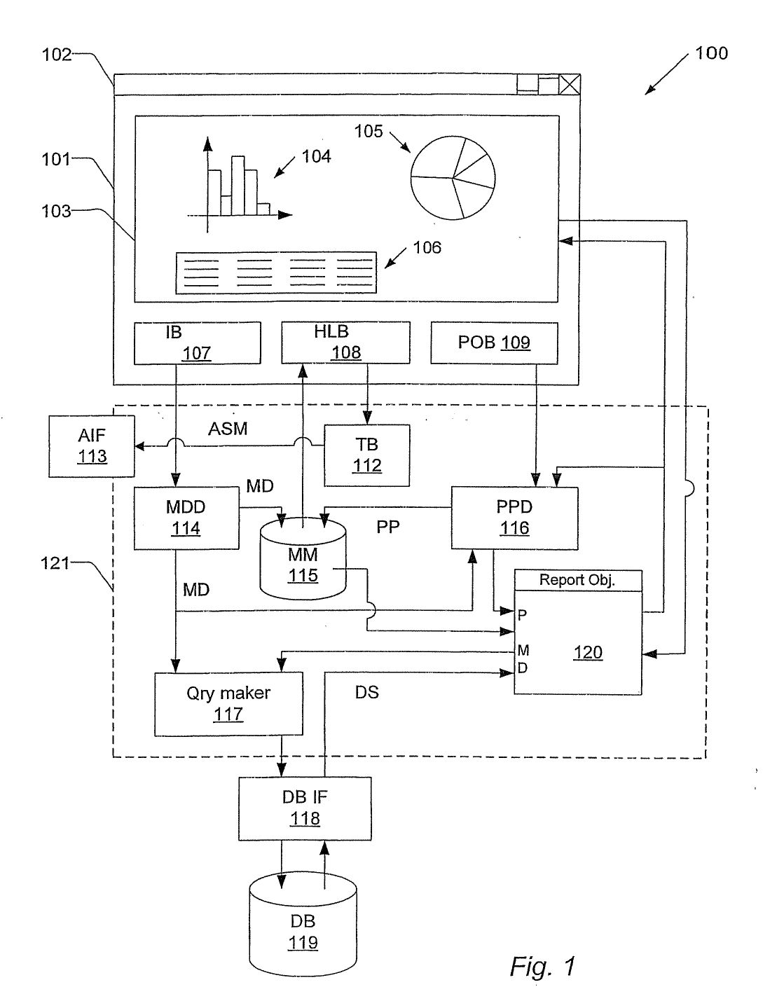

FIG. 1 shows a block diagram of a computer system for preparing a graphical presentation of a dataset selected from a database by use of a set of metadata items;

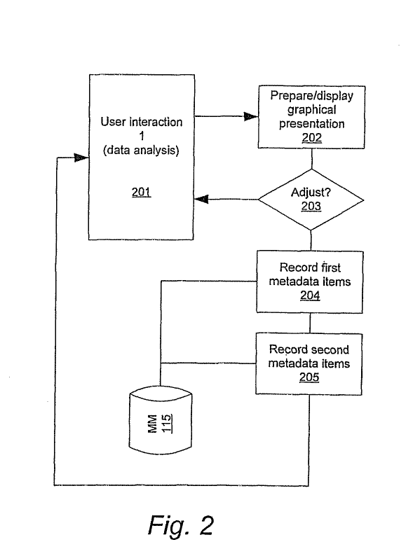

FIG. 2 shows a flowchart for recording a set of metadata items in connection with a first user interaction;

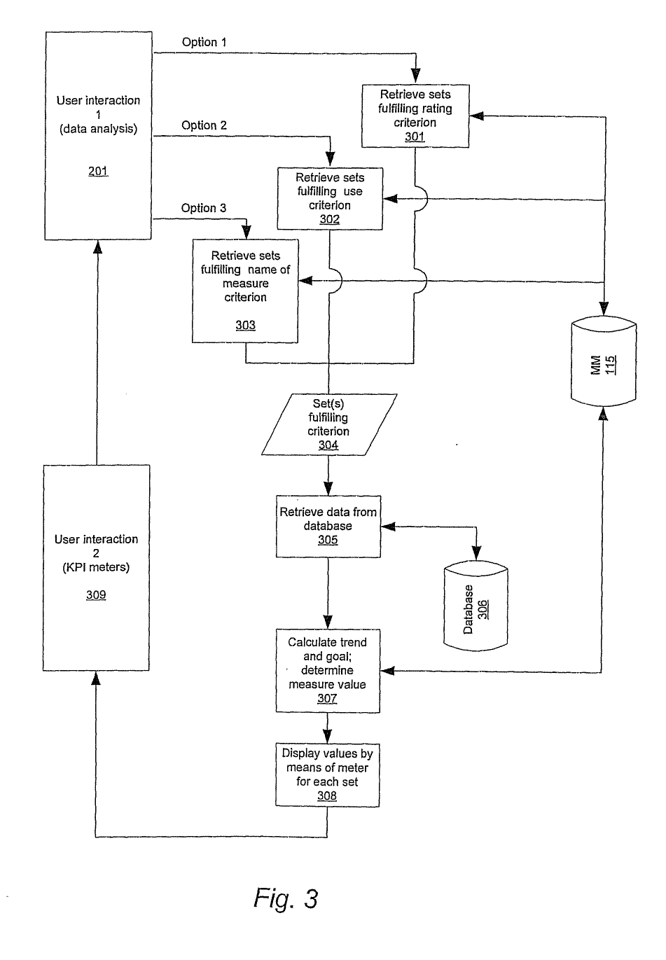

FIG. 3 shows a flowchart of preparing a key performance index from a specified measure in a predefined way, where the measure is specified according to different options; and

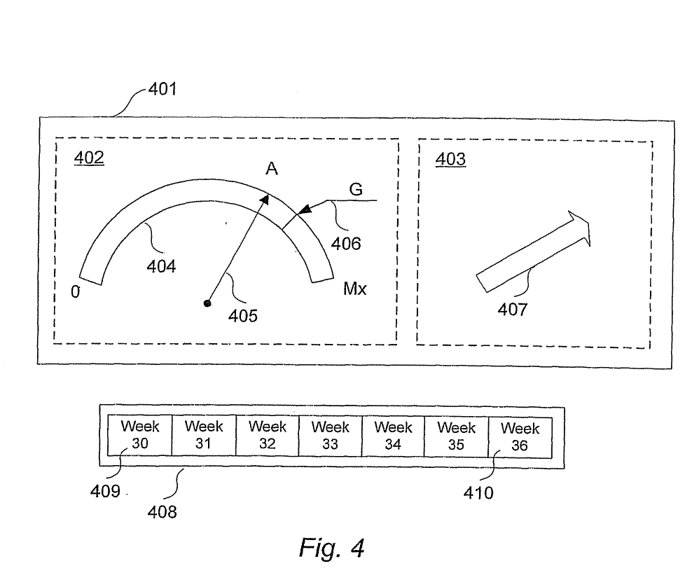

FIG. 4 shows a data meter and a graphical control object.

FIG. 1 shows a block diagram of a computer system for preparing a graphical presentation of a dataset selected from a database by use of a set of metadata items.

The system 100 comprises a user interface 101 which operates in combination with a middleware component 121 and a database DB, 119 with a database interface DB IF, 118.

The middleware component 121 provides functionality of the user interface 101 and is configured to receive inputs from the user interface and provide outputs to the user interface 101. The middleware component 121 provides contents to the user interface 101 from the database 119. The database 119 is accessed via the database interface 118. The middleware component is also configured to submit a query to the database 119 via the database interface 118 and to retrieve a result dataset from the database 119 via the database interface. Preferably, the database interface comprises a cache memory for fast retrieval of a previously retrieved dataset.

The user interface 101 is shown in the form of a window which has a control bar 102 with controls for closing, maximizing and minimizing the window on a display. The window comprises control components in the form of an input text box 107, a track history list box 108, a presentation options box 109, and a data report 103 in which different graphical presentation objects 104, 105, 106 are arranged. The data report can thus be arranged as a container of the presentation objects. This data report or container is also designated a view or view structure. Different graphical presentation objects are arranged in the view, e.g. as shown a bar chart object 104, a pie chart object 105, and a table object 106. These graphical presentation objects each provides a presentation of a dataset retrieved from the database 119.

The user interface 101 and the middleware component 121 provide in combination the following functionality:

In a first situation, a user can submit a request for a dataset to be presented by means of the view or data report 103. The request can be submitted in the form of a natural language or pseudo-natural language comprising words or text items which identify metadata items in the database 119. The request is processed by a metadata determining unit 114 of the middleware component 121. The metadata determining unit 114 provides an output with metadata items for identifying a dataset in the database 119. The metadata items are stored in a record in a metadata memory MM, 115. Further, the metadata items are forwarded to a query maker 117 which provides a formal query according to a syntax accepted by the database interface 118. The database interface 118 retrieves the dataset identified by the metadata items, and thus the formal query, from the database 119.

The retrieved dataset is provided to a report object 120 which collects the metadata items, for identifying the dataset, and presentation properties for rendering a presentation of the dataset in the view 103. Additionally, the report object provides methods for interacting with the view or the graphical presentation objects thereof.

The presentation properties are provided by a presentation properties determining (PPD) unit 116 which has a first mode where presentation properties are determined automatically from the metadata items, MD, provided by the metadata determining unit 114. In a second mode the PPD unit 116 receives a user's input to modification of the presentation properties via the presentation options box 109. Thereby, the presentation can be adapted to a user's preferences. In a third mode, a combination of functionality of the first and second modes is provided.

The presentation properties provided by the PPD unit 116 are optionally stored in the record containing the metadata items of the presentation.

In a second situation, a user can retrieve a former request for data, in the form of metadata items, stored in a record. The user can make a choice to select the record from the metadata memory 115 by means of the history list box 108 on the user interface 101. Further, the user is provided with an option of selecting a transformer of a transformer bank TB, 112. The transformer takes the metadata items, representing the former request for data, and provides the metadata as application specific metadata, ASM, to an application interface AIF, 113. The application interface 113 is configured to launch an application or a function of an application augmented by the application specific metadata. This is described in detail in co-pending application EP 1 659 503 (query tracking).

In a third situation, a user can request further data by an action directed directly to an element of a graphical presentation object of the view. In response to detecting the action, datasets of the individual presentations of the view are changed to provide for exploring or analyzing the datasets further. This is described in detail in co-pending application EP 1 577 808 (Hyper-related OLAP).

In a fourth situation, a user can request display of a key performance indicator by means of a data meter. This is described in detail in connection with FIGS. 3 and 4.

Reverting to the first situation, a user can request data by means of the input text box 107 wherein the user can write a question in a natural language in a preferred language e.g. the English language. From a user's perspective this question constitutes a query to the database 113. In an exemplary embodiment the database 113 can contain the following data items, wherein the data items are categorized as measures or dimensions and wherein a dimension exists at different levels such as day, month, and year:

| Measures: | Dimensions: |
|---|---|
| ‘turnover’ | ‘time’ (level 0: Year; level 1: Month; level 2: Day) |
| ‘cost’ | ‘Customer’ (level 0: Group; level 1: Name) |
| ‘sales’ | ‘Product’ (level 0: group; level 1: Name) |
| ‘revenue’ | ‘Country’ |
| ‘budget’ | ‘BusinessUnit’ |

Thereby e.g. the following questions can be asked:
1) I would like to see ‘cost’ grouped by ‘time, month’
2) I would like to see ‘turnover’ grouped by ‘time, month’, ‘customer, group’ and ‘product, name’
3) I would like to see ‘turnover’ for year 2004
4) I would like to see ‘country’

A question like the above ones are forwarded to a metadata determination unit 114 which is arranged to identify metadata items and their category and levels by parsing the question. The metadata determination unit 114 can be configured in different ways e.g. to identify a metadata from its name or a fraction of its name or from a letter combination using a phonetic search (also known as a ‘sounds-like’ search).

Based on the identified metadata items, the metadata determination unit 114 is able to look up a metadata memory 115 of previously used combinations of metadata and presentation properties. The contents of the storage memory 115 can have the following form as shown in table 1:

TABLE 1

| Data | Presentation | Frequency |
|---|---|---|
| Time, Level 1 | type = Barchart; legend = off; | 3 |
| Turnover | labels = off; 3D- | |
| | effects = Orthogonal | |
| Country; | type = map; legend = off; | 3 |
| Contribution Margin | labels = on; 3D-effects = None | |
| Customer, Level 0; | Type = Crosstab; legend = off; | 2 |
| Turnover; | labels = off; 3D-effects = None | |
| Cost; | | |
| Contribution Margin | | |
| . . . | . . . | . . . |

By searching the storage memory 110, with contents as shown in table 1 above, for a match on the data items and levels identified from the question, it is possible to determine whether a previous presentation matching the question has been used. Thereby preferred presentation properties can be found. If for instance it is determined that a question involves the data item ‘time, level 1’ and ‘turnover’, it can be deduced that the preferred presentation of these data items is a bar chart with properties as shown in table 1 above.

Presentation properties are determined by the presentation determining unit 116 based on the result of the search for matching data items and levels. The determined presentation properties are stored in a presentation memory object 120.

The metadata determining unit 114 converts the question or the metadata, as the case may be, to a query that can be submitted to a database 119 via a database connection. In response to the query, the database provides a result dataset. This result dataset is sent to a presentation memory object 120. Thereby the result dataset and the presentation properties are handled in the same memory object 120.

Via the presentation determining unit 116, the presentation properties from the data object or from the presentation options box 109 can be used for updating the frequency count and/or another update of the storage with the registered combinations of data and presentation properties in storage memory 115. The frequency count and/or another update of the storage can be updated in response to a user changing focus from the data report 103 to the input box 107 and/or closing or minimizing the window 102. Alternatively, a button or other control (not shown) on the user interface 101 can be used as an acceptance of storing the presentation properties of the present presentation and/or update the frequency count. In the latter case, a more transparent update is provided.

In the third situation, wherein a user can request further data by an action directed directly to a figure or element of the view, a data item is bound to the element and contains metadata associated with the element. The metadata is preferably a criterion in the form of a value or range of values of a dimension i.e. a so-called dimension value. Thus, when an element is selected, metadata associated with the element is retrieved or deduced. In that situation, the report object 120 is configured to identify such metadata items and provide modified datasets as determined by the metadata associated with the element in response to the action.

FIG. 2 shows a flowchart for recording a set of metadata items in connection with a first user interaction. The first user interaction 201 can take place as described in connection with any of the above-mentioned first three situations by means of the system 100. As a result of the user interaction a graphical presentation is prepared and displayed in step 202. Depending on further user interaction it is determined in step 203 whether any adjustments of the graphical presentation was made during the user interaction. In the positive event, any changes to the graphical presentation is prepared and updated in step 202.

In the negative event of step 203, first metadata items are recorded in step 204 and stored in the metadata memory 115. Alternatively, the metadata items are recorded in the positive event thus also recording metadata used in intermediate or draft presentations. Other events can also trigger recording of metadata items. The first metadata items select the dataset from the database and comprise a measure and a dimension. In an embodiment, the first metadata items comprise a level of the dimension and a criterion on the dimension.

Subsequently, second metadata items are recorded in step 205 and stored in the metadata memory 115. The second metadata items comprises other metadata comprising a metric representing use of the metadata items for preparing graphical presentations. In an embodiment, the second metadata items comprise calculated values or estimates such as trend values and goal values.

The second metadata items can also or alternatively comprise presentation properties. In an embodiment, the metadata items comprise a property representing a desired development of values of the measure. The property is e.g. a binary value indicating either that an increasing or decreasing development of measure values is desired. The property is determined from presentation properties e.g. relating to a colour coding scheme of a dataset that has been subject to a graphical presentation. If for instance relatively high values are mapped to a colour code representing the colour green and relatively low values are mapped to a colour code representing the colour red and any intermediate values to intermediate colours e.g. in a yellow tone, then the property can be asserted from the colour coding scheme e.g. by asserting that green represents a desired development and thus that higher values represents a desired development. Thereby, it is possible to estimate a goal value which is a function of the property representing a desired development. As an example a goal can be estimated by calculating the average of measure values and adding 20% in the above situation, where higher values represent a desired development.

When metadata items have been recorded the flow reverts to the user interaction 201 for any further data analysis. In this way metadata items are recorded as a user has a data analysis prepared. In a preferred embodiment this is carried out concurrently with the user interaction, but initiated at a predefined event or at predefined events e.g. when a user press an up-date button, requests a presentation, or at other predefined events detectable by the user interface.

FIG. 3 shows a flowchart of preparing a key performance indicator, KPI, from a specified measure in a predefined way, where the measure is specified according to different options. The first user interaction 201 can take place as described above by means of the system 100.

As a result of the user interaction 201, display of a key performance indicator is requested and an option is selected from the set of: Option-1, Option-2 and Option-3. The user can select the option in connection with request or the option can be predefined so as to avoid asking for selection of an option every time the request is issued.

In an embodiment, display of a key performance indicator commences on an automatically generated event 310 e.g. related to starting the system 100 or a software application comprising the user interface 101. The option can be predefined so as to avoid asking for selection of an option in response to the automatically generated event.

If Option-1 is selected, a metadata set stored in metadata memory 115 and fulfilling a performance criterion is retrieved in step 301. In case multiple metadata sets fulfil the criterion such sets are retrieved. The performance criterion selects metadata sets which comprise measure values and/or first metadata items and/or second metadata items that fulfil the criterion. For instance the performance criterion can be formulated to select metadata sets based on an expression which is a function of a trend value, goal value and a given data point of the measure. By means of the expression the values and sub-expressions of values can be assigned to different weighing factors.

Such an expression can be: KPI=((goal-actual)*a1+trend*a2)*c1.

where KPI is the result of the expression, goal and trend are metadata items, and a1 and a2 are weighing factors. (goal-actual) is a sub-expression. The value of KPI can be stored in the metadata set. By properly assigning a1 and a2 it is possible to define the importance of the values. c1 is the property representing a desired development e.g. being +1 or −1.

An alternative expression can be:

if a desired development is towards higher values (e.g. c1=+1) then:

if trend>0 and actual>goal then KPI=4

if trend>0 and actual<goal then KPI=3

if trend<0 and actual>goal then KPI=2

if trend<0 and actual<goal then KPI=1

This alternative expression creates up to four categories for the metadata sets.

It is possible to formulate other alternative expressions which provide a desired indicator.

By mapping an expression and a criterion to a phrase it is possible to assign metadata sets to a phrase like “show biggest problems” or “show biggest opportunities”. Here, these phrases are defined by means of the expression and the criterion. Thereby a very intuitive user interface can be established which requires only very few user inputs.

If Option-2 is selected, a metadata set stored in metadata memory 115 and fulfilling a use criterion is retrieved in step 302. The use criterion is defined to match the metric representing use. If for instance the metric holds a frequency of use, the use criterion selects a range of use frequencies. The criterion can be defined in different ways e.g. to select the most frequently used set or the three most frequently used sets. If for instance the metric holds a date of use, the use criterion selects a range of dates. The criterion can be defined in different ways e.g. to select the most recently used set.

If Option-3 is selected, a metadata set stored in metadata memory 115 and fulfilling a name criterion is retrieved in step 303. Sets comprising the named measure are selected.

As a result of either one of the options being selected, set(s) 304 fulfilling the respective criterion is/are retrieved.

Based on the set(s) 304 a dataset, with multiple multi-dimensional data points, is selected from the database 306 by use of the set of metadata items or at least a portion of the metadata items e.g. the first metadata items.

Subsequently, in step 307 calculation of a trend value of the measure over a term of the dimension, where the term is defined by a criterion on the dimension, is performed. Additionally or alternatively, calculation of a goal value for the measure at a predetermined dimension value based on values of the measure at dimension values fulfilling the criterion is performed.

In an embodiment, the trend value and goal value is retrieved from the database. Thereby, it is not necessary to calculate the values at this point in the flowchart.

Following the above, a step 308 of displaying a first value by means of the data meter is performed. The first value can be a measure value or goal value or trend value. In an embodiment, this step comprises displaying a collection of values e.g. the measure value and the goal value and the trend value.

FIG. 4 shows a data meter and a graphical control object. The data meter 401 comprises a first section 402 and a second section 403. The first section displays a meter scale 404 extending between values 0 and Mx. A pointer 405 points to a value A of the measure selected in a predefined way. The goal value G is shown by means of a pointer 406.

The second section 403 displays a trend arrow 407 which illustrates a trend value. The trend value can be in the form of a value representing the slope of a linearly approximated trend.

Below the data meter a graphical control object, which provides values of the criterion of dimension, is shown. The graphical control object is divided into divisions designated by 409; 410, where a division represents a level of dimension, and where one or more divisions are selectable from a user interface so as to provide the values of the criterion of dimension for providing an updated trend value. As shown, each division comprises labels represent numbers of weeks corresponding to respective level of dimension. The shown week numbers (week 30 to week 36) are selected for display since these week numbers fulfils the criterion on the dimension.

A user can select a subset of the divisions to change the term over which the trend value is estimated. In an embodiment, the control 408 provides values to several data meters like the data meter 401.

A control may be displayed to extend the scope of week numbers or other type of dimension level.

Generally, a well recognised organisation of data for analysis purposes comprises multidimensional databases e.g. so-called cube databases, or simply Cubes, for OLAP, OnLine Analytical Processing, databases. However, various types of databases and other types of data structures can be used for analytical processing, including relational databases, flat file databases, XML (Extensible Markup Language) databases, etc. In these databases elements of data can be denoted data items and can be defined as a field in a specific record, a cell in a table or spreadsheet, or a delimiter or tag separated or fixed-length data entity.

Despite their different structures each of the data items in the databases can be categorized as being so-called measures or dimensions. From a data representation point of view there are prima facie no differences, but from a user's point of view, a data item of the measures type can be interpreted as a measure value given a specific condition specified by an associated value of a data item of the dimensions type. A value of a data item of the dimensions type is also recognised as a so-called dimension value or a criterion.

Hence, for instance a range of data items categorized as measures can represent sales figures in an organisation. These sales figures are given a meaning when associated with the specific conditions of the time instances at which the sales figures represent the sales in the organisation. The time instances are represented by means of the dimension values. By categorizing the data items in this way an additional and more abstract way of representing data is provided; this additional representation is also denoted metadata. In the above example, time is thus a dimension and the sales figures are categorized as a measure.

The data processing techniques for analytical purposes operate on these data whatever the organisation of the data to provide a result of the analysis. For this purpose, an analysis task can be specified by a request to a database. The result of the analysis is then illustrated by means of a data report. The data report can be set up by a user who selects presentation objects and properties thereof by of a so-called ‘report generator’ or a ‘chart wizard’, wherefrom default layout properties or user-specified layout properties are selected before making the presentation. Especially, when the data report is presented on a graphical user interface it is also referred to as ‘a view’.

Moreover, generally, it should be noted that a dimension is a collection of data of the same type; it allows one to structure a multidimensional database.

Values of a dimension are denoted positions or dimension values or criteria. A multidimensional database is typically defined as a database with at least three independent dimensions. Measures are data structured by dimensions. In a measure, each cell of data is associated with one single position in a dimension.

The term OLAP designates a category of applications and technologies that allow the collection, storage, manipulation and reproduction of multidimensional data, primarily for analysis purposes.

Special modules may be provided to transform operational data from a source database or transactional database to analytical data in a data warehouse. In some situations it may be inconvenient to transform the operational data to analytical data which are stored in another database. Therefore the operational database, which is typically a relational database, can be emulated such that it exposes an interface from which the operational database is accessible as a multidimensional (analytical) database.

In the above, the term database can designate any type of database whether analytical or transactional, but it should be clear that analytical databases are preferred in connection with the present invention.

Values of a measure and dimension are generally designated data points or observations.

Further, in the above it should be noted that the term ‘presentation properties’ designates any type of properties related to presentations. Therefore, in practical embodiments, different definitions of which ‘presentation properties’ that are stored in ‘metadata records’ or ‘presentation property records’ can be applied. Typically, at least some presentation properties will be determined by or carried with graphical presentation objects.

It should be noted that the above description of a method can be implemented by a computer system with a memory loaded with a program that is configured to perform the method. Preferably, the computer system has a structure, when loaded with the program, as described above. However, it will be within the skills of a person skilled in the art to use other suitable structures for performing the method.

A program that is configured to perform the computer-implemented method as described above when run by a computer, can be distributed by means of a CD-ROM, DVD or other hard media or alternatively as a download signal via a computer network.

1. A computer-implemented method of preparing a graphical presentation on an electronic dashboard with a data meter for monitoring data, comprising:
on a first user interaction, preparing a graphical presentation of a dataset, with multiple multi-dimensional data points, wherein the dataset is selected from a database by use of a set of metadata items;
recording the set of metadata items in a metadata memory, wherein a metadata item in said set of metadata items comprises:
first items, comprising a measure and a dimension, which select the dataset from the database, and
second items, comprising a metric representing use of the metadata items for preparing graphical presentations;
displaying the graphical presentation on the electronic dashboard; on a second user interaction, determining a number of metadata item to retrieve, wherein the metadata item to retrieve comprises at least one measure fulfilling one or more of:
a first criterion comprising a mathematical expression,
a second criterion being correlated to the metric of use, and
a third criterion comprising at least one name of a measure;
retrieving from the metadata memory the number of metadata items to retrieve;
determining a first value based on the at least one measure fulfilling one or more of the first and the second and the third criterion;
displaying the first value on the data meter of the electronic dashboard.

2. A method according to claim 1, wherein the items which selects the dataset from the database comprise a level of the dimension and a criterion on the dimension.

3. A method according to claim 2, comprising:
calculating a trend value of the measure over a term of the dimension, where the term is defined by a criterion on the dimension;
by means of the meter, displaying the trend value.

4. A method according to claim 3, where different sets of metadata items are recorded; comprising:
from the different sets of metadata items, determining which recorded metadata set that fulfil a predetermined criterion on the metric representing use and the criterion that the criterion on the dimension is used in combination with the measure; and
providing that criterion on the dimension so as to define the term of the dimension.

5. A method according to claim 3, comprising:
displaying a graphical control object, which provides values of the criterion of dimension; and
dividing at least a portion of the graphical control object into divisions, where a division represents a level of dimension, and where one or more divisions are selectable from a user interface so as to provide the values of the criterion of dimension for providing an updated trend value.

6. A method according to claim 2, comprising:
calculating a goal value for the measure at a predetermined dimension value based on values of the measure at dimension values fulfilling the criterion; and
by means of the data meter, further displaying the goal value.

7. A method according to claim 6, comprising:
recording for the set of metadata items a property representing a desired development of values of the measure; where the goal value is calculated so as to be a function of the property representing a desired development.

8. A method according to any of claims 4, where the index is calculated so as to be a function of a value of the measure, the trend value, and the goal value.

9. A method according to claim 1, where the step of displaying a first value by means of the data meter comprises displaying a collection of values.

10. A method according to claim 1, where the step of displaying a first value by means of the data meter comprises displaying a collection of values, and where the collection of values is computed from values of items in the set of metadata items.

11. A computer program product which when run on a computer performs the method according to claim 1.

12. A computer readable medium encoded with a program which when run on a computer performs the method according to claim 1.

13. A computer system encoded with a program which when run on a computer performs the method according to claim 1.

14. A method according to claim 5, comprising:
displaying a graphical control object, which provides values of the criterion of dimension; and
dividing at least a portion of the graphical control object into divisions, where a division represents a level of dimension, and where one or more divisions are selectable from a user interface so as to provide the values of the criterion of dimension for providing an updated trend value.

15. A method according to claim 3, comprising:
calculating a goal value for the measure at a predetermined dimension value based on values of the measure at dimension values fulfilling the criterion; and
by means of the data meter, further displaying the goal value.

16. A method according to any of claims 5, where the index is calculated so as to be a function of a value of the measure, the trend value, and the goal value.

17. A method according to any of claims 6 where the index is calculated so as to be a function of a value of the measure, the trend value, and the goal value.

18. A method according to any of claims 7 where the index is calculated so as to be a function of a value of the measure, the trend value, and the goal value.

19. A method according to claim 2, where the step of displaying a first value by means of the data meter comprises displaying a collection of values.

20. A method according to claim 3, where the step of displaying a first value by means of the data meter comprises displaying a collection of values.
